(19) United States
(12) Patent Application Publication
(10) Pub. No.: US 2005/0081235 A1
(43) Pub. Date: Apr. 14, 2005

(54) System and method for accessing media in a data storage system

(76) Inventors: Daniel H. Raguin, Acton, MA (US); David Kent, Framingham, MA (US); Christopher J. Butler, Arlington, MA (US); David J. Kindler, Concord, MA (US)

Correspondence Address: Kenneth J. LuKacher;South Winton Court, 3136 Winton Road South, Suite 204, Rochester, NY, 14623, US

(21) Appl. No.: 10/965,570

(22) Filed: Oct. 14, 2004

Related U.S. Application Data
(60) Provisional application No. 60/510,914, filed on Oct. 14, 2003.

(51) Int. Cl. G11B 23/03

(52) U.S. Cl. 720/741; 720/736

(57) ABSTRACT

A data storage system is provided which utilizes cartridges having data storage media. The system has a housing having an optical data storage system, such as a holographic data storage system. Each cartridge has a window through which the media may be partially or fully removed when located in the housing, a slot through which the data storage drive can engage the media upon a positioning mechanism, and a shutter mechanism which closes the window and slot. When the cartridge is inserted in the housing, its shutter mechanism is engaged to open the window and slot of the cartridge, and the media is coupled through the slot to the positioning mechanism, which partially or fully removes the media from the cartridge through the window for presentation to the optical data storage system. Once operation on the media is completed by the optical data storage system, the positioning mechanism moves the media back into the cartridge and is decoupled from the media. The shutter mechanism is engaged to close the window and slot prior to ejecting the cartridge from the housing. When media is sensitive to external light, the cartridges prevent external light from reaching media contained therein when the window and slot are closed.

### DESCRIPTION

This application claims the benefit of priority to U.S. Provisional Application No. 60/510,914, filed Oct. 14, 2003, which is herein incorporated by reference.

### FIELD OF THE INVENTION

This invention relates to a system and method for accessing media in a data storage system, and in particular to, a system and method for accessing holographic data storage media in a holographic data storage system in which the media can be partially or fully removed from a cartridge for presentation to an optical system for holographic read and/or write operations, and the holographic media is returned back in the cartridge after operating on the media. In read/write holographic data storage systems, the invention is especially useful in that the holographic media is at all times in light-tight conditions when in the cartridge, or in the data storage system accessing the cartridge, such that the media is not subject to external light to which the media is sensitive. The cartridge may also be used in read only holographic data storage systems, where the cartridge and environment of the system need not be light tight.

### BACKGROUND OF THE INVENTION

In conventional disk-based data storage devices, the pick-up head for the device generally moves such that the pick-up head can track different radial positions of the data storage media. This is true for optical disks, such as compact disks (CD) and digital video disks (DVD), and magnetic disks, such as fixed and removable hard disks and floppy disks. In these disk-based data storage systems, while the pick-up head can be moving or stationary in a radial direction of the disk, the disk is also spinning, thereby enabling the optical pick-up head access to the complete area of the data storage media.

Holographic data storage systems (HDSS) enable storage of larger amount of data than possible on a CD, DVD, or magnetic disk. An example of an HDSS is shown in U.S. Pat. No. 5,621,549, which describes the actuating of a holographic storage media along a single linear direction in the plane of the surface of the holographic storage media to access different areas of the storage media for reading and writing on the media. Prior to recording information on holographic media, exposure of the media to light negatively affects the ability to record information on the media. Further, once recorded upon, unrecorded areas of the media remain sensitive to the exposure to light. Optical disks of CD or DVD formats are different from holographic media in that their recordability is not affected by exposure to light, and CD or DVD drives utilize non-holographic methods for reading and/or writing data. Conventional magnetic disks, such as floppy disks, are also not affected by light, and like optical disks, do not require packaging or drive mechanisms that prevent light from reaching their recordable surfaces.

U.S. Pat. No. 5,526,337 describes a package or cartridge that houses a holographic media storage disk. The package is made of opaque material, is light-tight, and has a data window allowing access to the holographic media by a HDSS, and the data window has a sealing mechanism by which the holographic media can be sealed from light when the media is not being accessed. The package may further have a locking mechanism for preventing the data window from being accessed without a proper unlocking mechanism.

Prior art approaches for packaging for data storage media also include packages sold by Sony Corp. of Japan and SyQuest Technology, Inc. of CA, U.S.A. For example, in the Sony Blu-ray disk cartridge, a data window shutter system is provided having a component with a circular boundary that has grooved teeth towards the edge of the cartridge boundary. These teeth form a gear that is accessed by a motor external to the cartridge. By actuating this geared component of the shutter system, one causes other components of the shutter to move and rotate in such a way that a longitudinal slot along a substantially radial position along the disk to open up on the bottom of the cartridge, allowing access to radial areas of the blu-ray DVD disk contained within. In the SyQuest Sparq removable hard disk package, a rotary aperture at the front of the package is slid open along a trail by a mechanical motor motion that pulls on a tab at one end of the rotary aperture. In this manner, the Sparq cartridge allows the magnetic pick-up head of the drive to access inside of the cartridge and the magnetic disk media contained within. In neither of these Sony or SyQuest packages, nor in the package of U.S. Pat. No. 5,526,337, is capability provided for allowing for the data storage media contained within their respective packages or cartridges to be locatable for actuation outside of the boundaries of the cartridge in a data drive system.

### SUMMARY OF THE INVENTION

It is an object of the present invention to provide an improved data storage system for accessing media contained in cartridges which enables actuation, e.g., read/write, upon the media outside the boundaries of the cartridge.

It is a further object of the present invention to provide an improved data storage system for accessing media contained in cartridges in which the system can engage the media in each cartridge and then position the media partially or fully outside the cartridge.

It is another object of the present invention to provide an improved data storage cartridges for holographic data storage media having a normally closed window which is opened in a holographic data system (or drive) to enable at least part of the media in the cartridge be moved and positioned with respect to holographic read/write optics with respect to different locations on the media, and returning such media to the cartridge and closing the window prior to ejecting the cartridge from the holographic data storage system.

It is another object of the present invention to provide an improved data storage cartridges having read/write holographic data storage media in which each cartridge prevents external light sensitive to the media from reaching the media while enabling the media in the cartridges to be partially or fully removable to enable actuation by a data storage system outside the cartridge.

Briefly described, a holographic data storage system (HDSS) embodying the present invention has one or more cartridges having data storage media, a window, and a shutter closing the window, in which the shutter is externally engagable to open the window, and a housing having an optical system for at least one of reading, writing, or reading and writing data on data storage media. The housing has an aperture through which one of the cartridges is partially or fully received, and a motor driven gear that engages a track along the shutter to move the shutter to open the window of the cartridge, and a positioning mechanism which engages the media through one of the window or another opening or slot in the cartridge, and moves the media partially or fully from the cartridge through the window to present the media to the optical system. After operating on the media, the positioning mechanism moves the media back into the cartridge through the window prior to disengaging from the media, and then the shutter is closed over the window prior to ejecting the cartridge from the system.

At all times the media is prevented from being exposed to light external in the housing of the system or the cartridge. However, in read-only media where the optical system enables only read operations to take place, the cartridge and housing need not be light-tight, since holographic media exposure to external light does not affect read-only media or read-only holographic operations.

In one example of the cartridge, the media may be in a disk format and each cartridge has a chamber having a cylindrical wall with the window, and the shutter is rotatable along the interior of this wall to open and close the window. A slot (or opening) is provided in another wall for accessing the hub of the media. A pivotal hub cover is provided, such that the hub cover and part of the shutter closes the slot, and rotation of hub cover is coupled to rotation of the shutter to open and close the slot. When the window and slot are open, the media is engagable upon the positioning mechanism through the opening to the hub of the disk, and the slot is of sufficient size to enable the positioning mechanism to move at least a part of the media through the opened window outside the boundaries of the cartridge. The positioning mechanism may be provided by a translation stage and a rotatable stage mounted to the translation stage. The spindle of the rotory stage is positioned for coupling to the hub of the media, and then the translation stage moves in a direction through the slot of the cartridge to at least partially remove the media from the cartridge, or in a reverse direction through the opening of the cartridge to return the media to the cartridge. When the media is returned into the cartridge, the spindle disengages from the hub of the media, the shutter and hub cover closes the window and slot, respectively, and the cartridge may be ejected from the housing.

In another example of the cartridge, the media in the cartridge may be in a rectangular card format, in which the positioning mechanism is provided by linear motors (or stages) which are coupled to the sides of the card to partially or fully remove the card for presentation to the optical system, and then returning the card to within the cartridge. A shutter mechanism, e.g., door, is opened or closed to enable access to the card by the positioning mechanism.

The aperture of the housing may have one or more light blocking members for preventing light from entering the housing after the cartridge passes partially or fully through the aperture.

A method is also provided having the steps of: providing a housing having an optical system for at least one of reading, writing, or reading and writing data on holographic data storage media; receiving a cartridge fully or partially through an aperture in the housing; removing the media partially or fully from the cartridge received in the housing to present the media to the optics; and inserting the media back into the cartridge after presentation to the optics. Where the cartridge has a window which is normally closed when the cartridge is outside the housing, the removing step further provides for opening the window, and positioning the media partially or fully from the cartridge through the opened window to present the media to the optics.

One advantage of the system and method is that by having a cartridge wherein a portion of it opens to allow a data storage media to be actuated outside of said cartridge can provide a lighter mass for the HDSS to servo than if the HDSS needed to servo both the cartridge and the media inside. Another advantage is that by actuating only the media and not the cartridge and media that for a HDSS that has two opposing read and write optical modules that the opposing elements or fixtures of each module can be brought closer together since only the media needs to clear the gap between the modules and not a thicker cartridge.

Although the system, method, and cartridge are described below for use with holographic optical systems and media, they may be used in other non-holographic data storage systems (e.g., optical magnetic, or combined optical magnetic read/write systems).

### DETAILED DESCRIPTION OF THE DRAWINGS

The foregoing objects, features and advantages of the invention will become more apparent from a reading of the following description in connection with the accompanying drawings, in which:

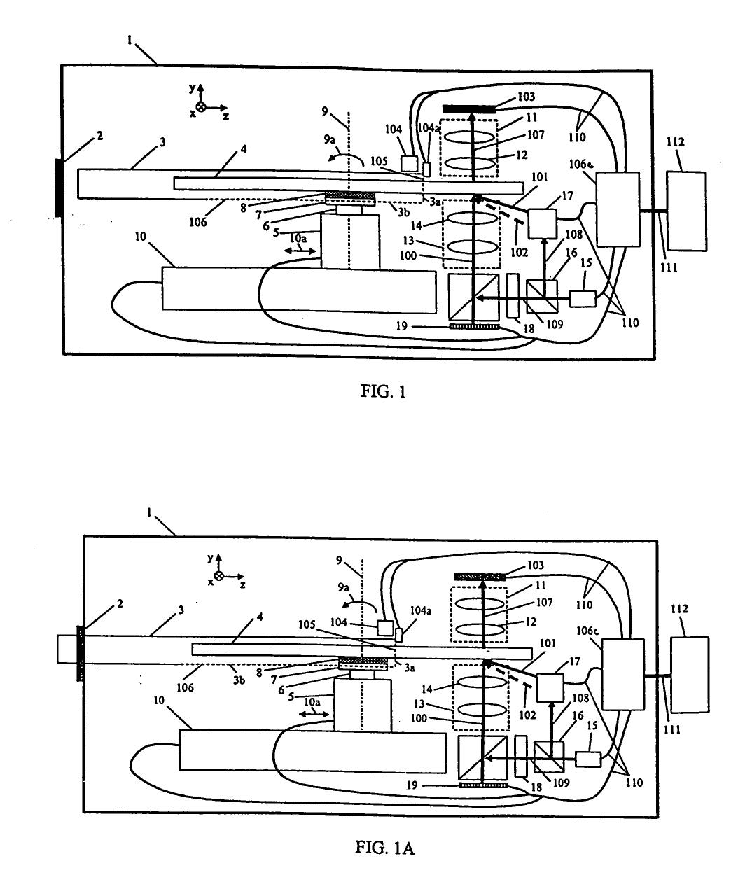

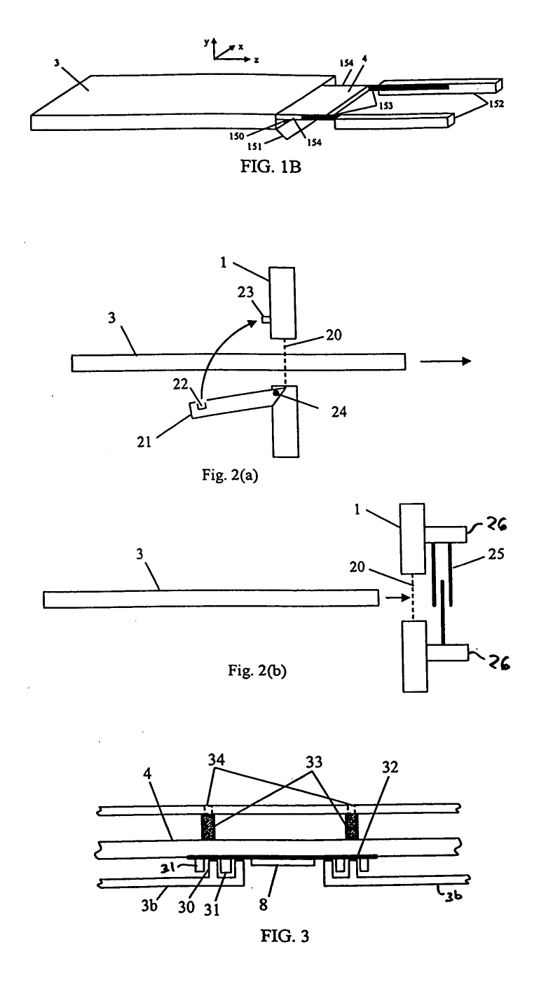

FIG. 1 is a block diagram of a holographic media cartridge in a holographic data storage system in accordance with the present invention;

FIG. 1A is a block diagram similar to FIG. 1 showing an embodiment of the system in which the cartridge is partially outside the system when the media is being actuated outside the boundaries of the cartridge;

FIG. 1B is a diagram of an example of a cartridge which may be used in the system of FIGS. 1 or 1A for media in a card format, and shows a different media positioning mechanism than of FIGS. 1 and 1A;

FIGS. 2A and 2B are schematic diagrams of two embodiments of the light tight aperture of the holographic data storage system of FIG. 1 through which passes the media cartridge pass into and out of the holographic data storage system;

FIG. 3 is a partial schematic cross sectional view of the cartridge showing an optional light-tight seal on the hub of the media and interlocking rings from the media and bottom wall of the cartridge;

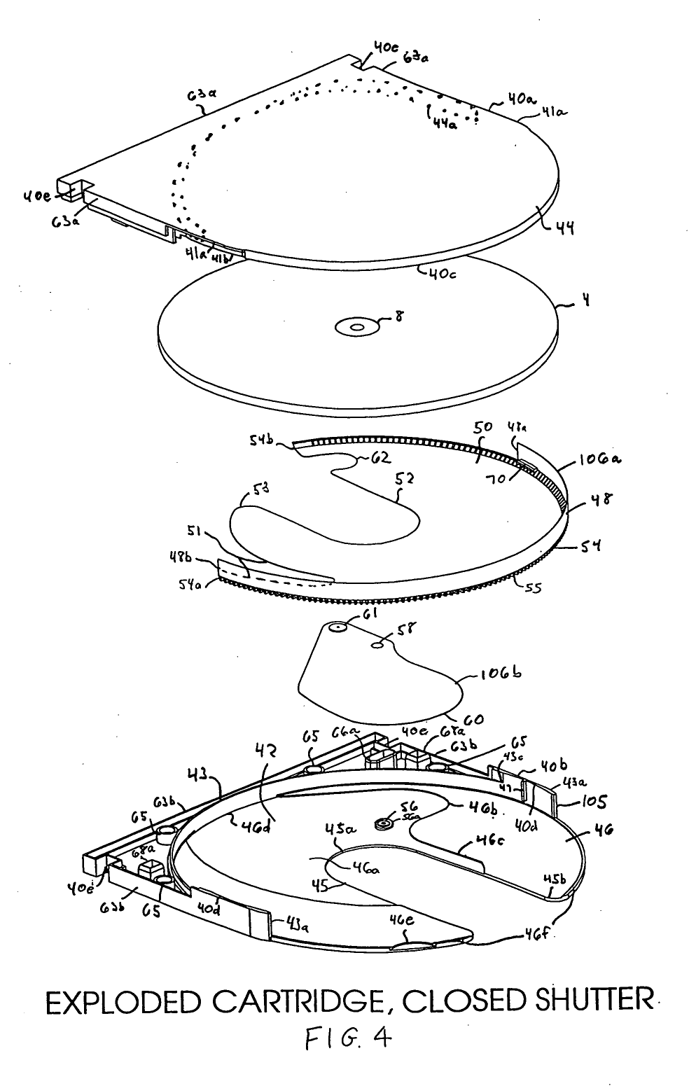

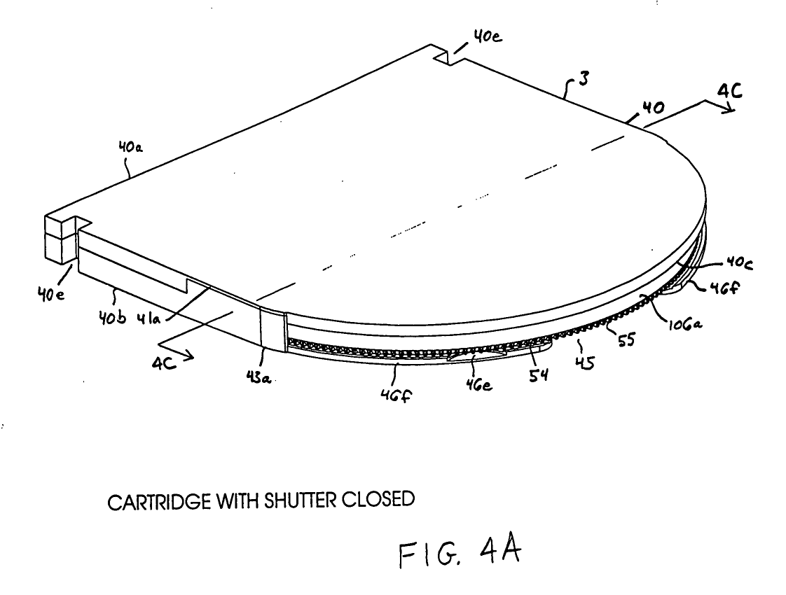

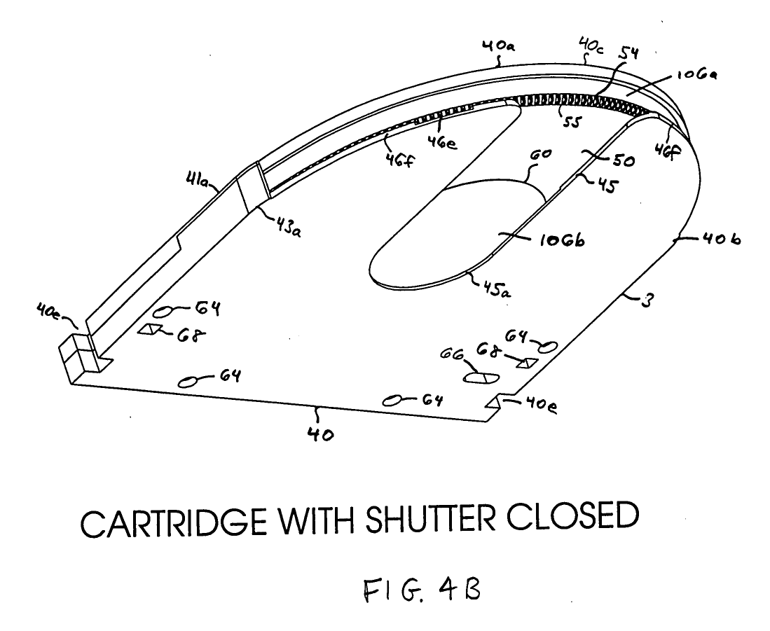

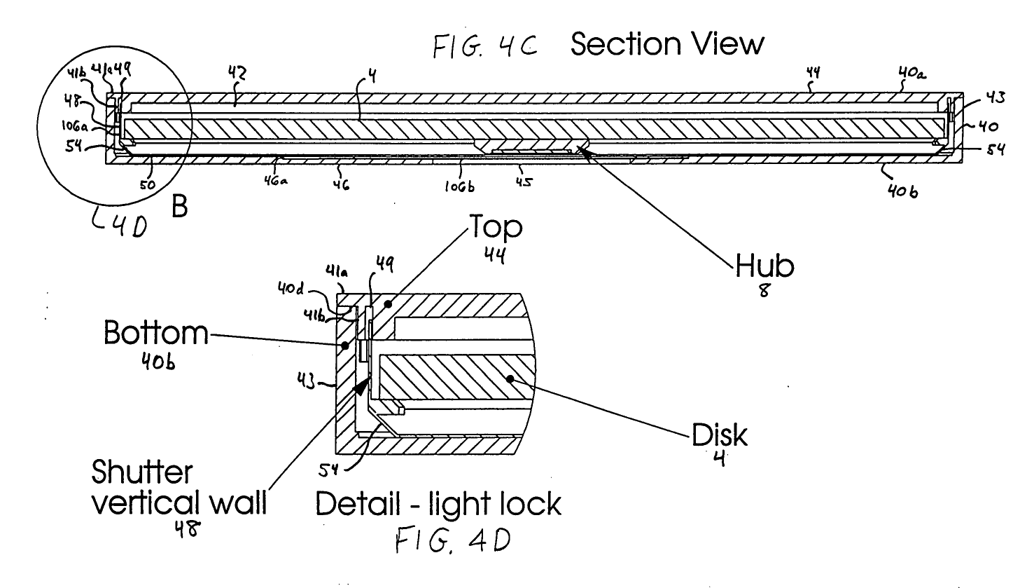

FIG. 4 is an exploded view of the cartridge of FIG. 1 having media in a disk format;

FIGS. 4A and 4B are the top and bottom perspective views, respectively, of the cartridge of FIG. 1 with the shutter closed;

FIG. 4C is a cross sectional view of the cartridge along line 4C-4C in FIG. 4A;

FIG. 4D is a detailed view of a circled portion of FIG. 4C labeled 4D;

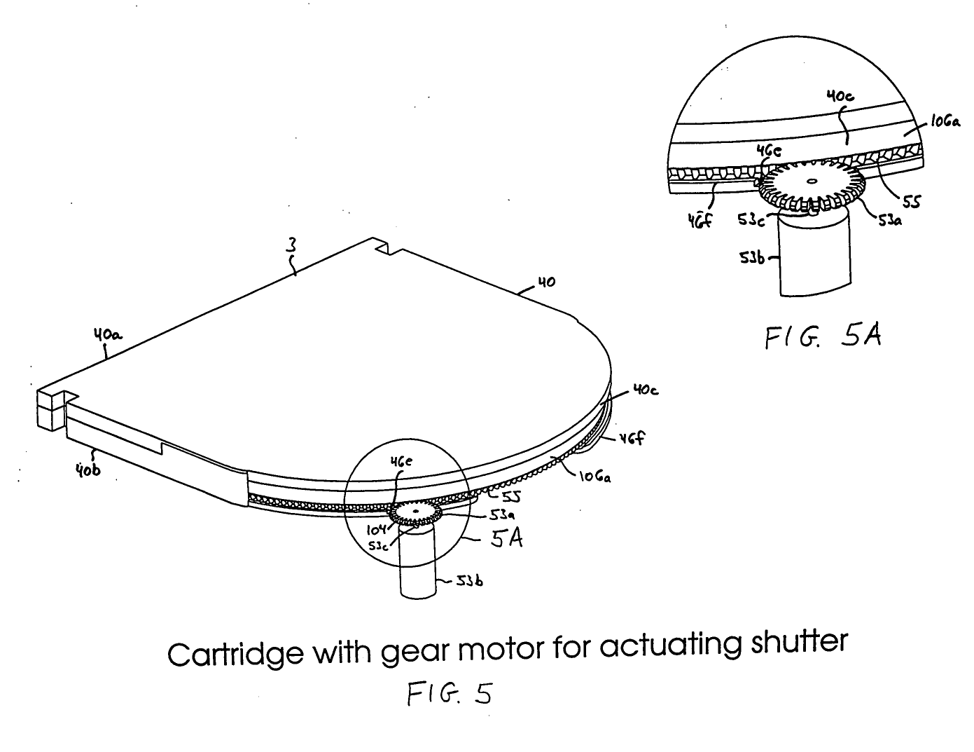

FIG. 5 is a top perspective view of the cartridge similar to FIG. 4A showing the gear coupled to a motor engaging a gear rack of the shutter mechanism;

FIG. 5A is a detailed view of a circled portion of FIG. 5 labeled 5A;

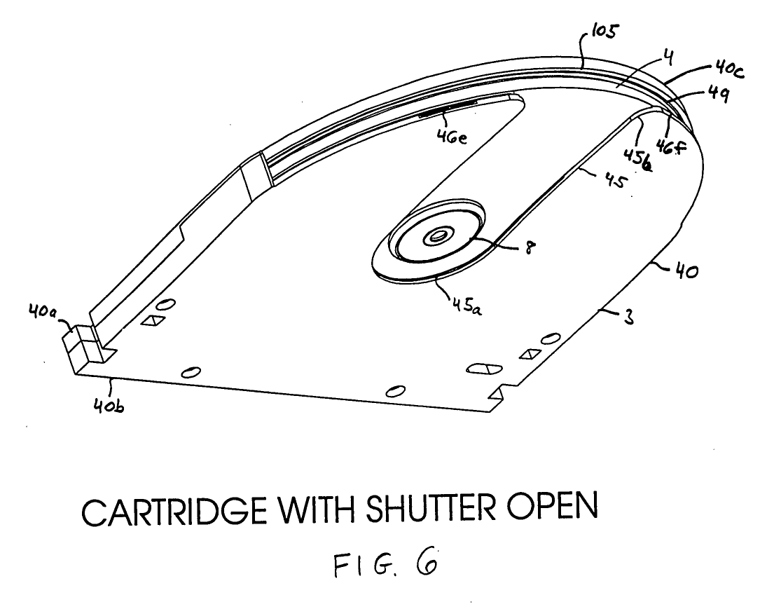

FIG. 6 is a bottom perspective view of the cartridge similar to FIG. 4B but with the shutter mechanism in an open position; and

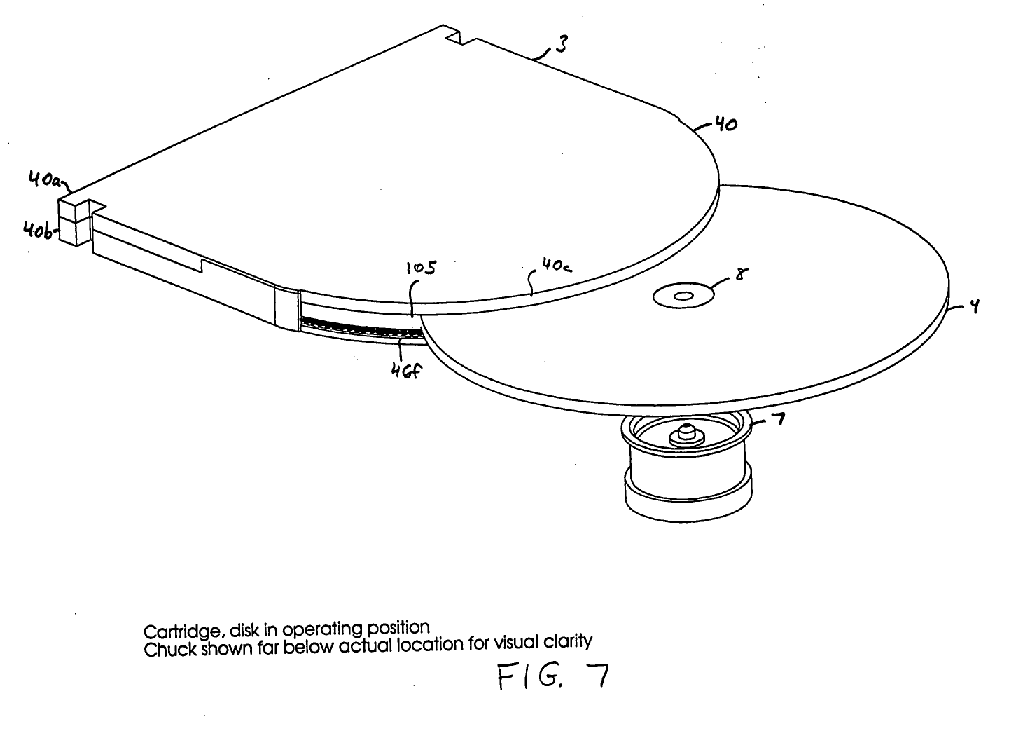

FIG. 7 is a top perspective view of the cartridge similar to FIG. 4A with the media disk shown partially removed from the cartridge, and the chuck shown in an exploded view with respect to the cartridge and media.

### DETAILED DESCRIPTION OF THE INVENTION

Referring to FIG. 1, a block diagram of the HDSS (or holographic drive) is shown having a housing 1 with an aperture 2 through which a cartridge 3 housing holographic media 4 can be inserted into the HDSS. The aperture 2 is light-tight to seal the HDSS interior from light external to the housing 1 when the cartridge 3 is either fully inserted and/or fully removed from housing 1. Examples of such aperture with a light-tight sealing mechanism are described later in connection with FIGS. 2A and 2B. Except for aperture 2, the housing 1 is itself light-tight such that external light cannot be received through the walls of the housing. The housing may be constructed of walls of opaque material, or having opaque material coated surfaces, or of other material or coatings that prevent transmission of light or allow only light of a wavelength the holographic media is not sensitive to.

Media 4 represents holographic recordable material, such as available from Aprilis, Inc., of Maynard, Mass., U.S.A. The media may be in various forms, such as a disc, planar card, or other shapes, such that holographic recordings may be made in the volume of the media. For purposes of illustrating the invention, the media is described as being a disc having a centrally attached hub 8. The housing 1 may have a cartridge loader mechanism similar to other cartridge loader mechanisms of other types of data drives for pulling in and positioning a cartridge, and ejecting a cartridge, such as used in drives with earlier mentioned cartridges from Sony Corp. or SyQuest, but provides for partially or fully loading the cartridge prior to opening a cartridge window.

Cartridge 3 represents a light-tight housing which blocks external light from entering the cartridge, as such, the cartridge may be made of plastic material non-transmissive of light and/or having light blocking coatings on surfaces to prevent light from reaching the media when within the cartridge, or only allows light of a wavelength the holographic media is not sensitive to. The cartridge 3 has a window (or opening) 105 extending along side wall 3a of the cartridge sized to provide an aperture through which all or part of the media can be removed from the cartridge, as illustrated in FIG. 1. The cartridge also has a large slot (or opening) 45 along the bottom wall 3b having a closed end 45a sufficient to enable access to the hub 8 of the media 4 by the holographic drive, and an open end 45b which opens to the opening provided by window 105. To provide a light-tight seal in the cartridge 3, a shutter mechanism 106 is provided in the cartridge which when in a closed position closes the window 105 to block light from entering the cartridge 3 along side wall 3a or bottom wall 3b, and thereby prevent light from entering regions of the holographic media that are photosensitive. When located in the holographic drive, the shutter mechanism 105 is engaged to open window 105, as described below. One example of the cartridge 3 with such a shutter mechanism is described in more detail later in connection with FIGS. 4-7. For purposes of illustration, the shutter mechanism 106 is shown in FIGS. 1 and 1A as a dashed line along cartridge 3.

When the cartridge is inserted into housing 1 via aperture 2, the movement of the cartridge 3 in the z direction (as indicated by arrow 10a) trips a contact 104a (e.g., an optical or mechanical switch) that relays a signal to a motor operating gear 104 (or to a programmed computer system which sends control signals to the motor of gear 104) to open the shutter mechanism 106. The motor driven gear 104 engages a gear rack 55 of the shutter mechanism 106 which rotates shutter mechanism 106 in a first direction to open window 105, or later prior to ejection of the cartridge in the reverse direction to close window 105 (FIGS. 5 and 5A).

A positioning mechanism in housing 1 engages media 4 after window 105 is opened. The positioning mechanism includes a translation stage 10 and a rotary spindle 6 attached to a rotary motor mounted upon the translation stage. The rotary spindle 6 has a chuck 7 which can be positioned to engage the media, thereby attaching the media 4 to the positioning mechanism. The translation stage 10 is movable bi-directional along the z axis as indicated by arrow 10a, but may also be movable along the x and y axes. The chuck 7 thus can gain access to the hub 8 of the media 4 through slot 45. The spindle 6 moves upwards to engage the hub 8 of the media and/or the media drops down to engage onto the spindle 6, as will be described later in more detail. The chuck 7 engages the media 4 by one of mechanically coupling, magnetic attraction, or combination thereof, such that the media 4 is movable by the positioning mechanism. Once in engagement upon the spindle 6, the translation stage 10 by moving the spindle 6 along slot 45 moves all or part of the media 4 out of the cartridge through the window 105 for presentation to a holographic optical system for reading and/or writing operations on the media. The translation stage 10 in combination with rotation of the media upon spindle 6 enables positioning of media 4 at one or more locations with respect to such optical system. In this manner, means are provided by which the holographic media is removed from the cartridge and servo'd in front of the optical elements that serve as the write and/or read optical modules for the HDSS. Unlike prior art data storage media, a portion or all of the holographic media can thus be actuated outside the boundaries of the cartridge.

As stated earlier, the chuck 7 engages (or attaches to) the hub 8 of media 4 that include lowering the cartridge 3 such that the hub meets the chuck, by raising the rotary motor 5 such that the chuck meets the hub, or a combination of these two motions. For example, the cartridge loader, while in the process of loading the cartridge into the HDSS, can move the cartridge 3 in the z direction but then drop the height of the cartridge (down in the y direction) such that the hub 8 of the holographic media 4 contained within the cartridge 3 meets the chuck 7 of the rotary spindle 6, as typically performed in non-holographic data storage devices, such as magneto-optical drives and floppy disk drives. In another example, the rotary spindle 6 and the chuck 7 can rise up to make contact with the hub 8 of the holographic media 4 as typical of non-holographic data storage systems, such as CD and DVD drives on desktop computers.

The attachment of the hub 8 and the chuck 7 may be accomplished by magnetic means. For example, either the hub 8 or the chuck 7 is made from a magnetic material such as 400 series stainless steel or any other magnetic steel or metal, which if it is not corrosion resistant is provided with a suitable coating. The remaining mating component houses a magnet in order to create the magnetic attraction of the two components. Such attachment of the hub 8 and chuck 7 may be similar to that used in typical magneto-optical drives, wherein the hub of a magneto-optical disk is made from stainless steel and the chuck of the rotary spindle contains at least one magnetic component.

Alternatively, the hub 8 and the chuck 7 may be mechanically attached. For example, a cartridge containing the holographic media can be loaded into the drive and once the cartridge is fully loaded, the spindle 6 can rise up to meet the hub of the holographic media. The spindle 6 can contain a mechanical chuck that through the use of springs and clasps, can grab the hub 8 of the holographic media 4 with sufficient force so that the media can be servo'd in position in accordance with the specification of the HDSS. In the case of a mechanical attachment of the rotary spindle 6 to the holographic media 4, the hub 8 does not require to be bonded, or otherwise attached, to the holographic media. Instead, a through hole may be provided in the media, such as in the center thereof, that the mechanical chuck of the rotary spindle 6 can attach itself to. Such engagement may be similar to engagement of a spindle to an optical disk in DVD/CD players in desktop personal computers. Optionally, chucks and hubs with key devices of U.S. Pat. No. 5,883,880 may also be used to enable self-referencing to each other.

Optionally, the window 105 of the cartridge can be opened and closed by harnessing the mechanical energy of the cartridge loader that loads the cartridge in and out of the HDSS, and through the use of the motor operating gear 104 that opens the window 105 separately from the motion of the cartridge. For example, a gear system with gear 104 in contact with an external surface of the cartridge shutter mechanism 106 that has linear track 55 of grooves can be actuated by the motion of the cartridge in the z direction produced by the cartridge loader. The mechanical work done by the cartridge loader in the z direction can be stored in a spring that is wound driven by such gear. Once the cartridge is fully loaded, the energy stored by wound spring can be discharged into a separate gear motor to gear 104 that opens the shutter mechanism.

FIG. 1 illustrates the position of the media 4 when partially removed from the cartridge for presenting the media to optics (or optical systems) for read and/or write operations outside the boundaries of the cartridge. Depending on the travel distance between such optics and the cartridge loader, or if the media is of a non-circular shape (e.g., rectangular card), the entire media may be fully removed from the cartridge if needed to access regions of the media. Further, when the media form factor is non-circular, rotational motion upon a spindle is not required, and the translation stage supporting the media can move the media along x and z axes (and optionally y axis) to access different locations of the media.

In FIG. 1, the rotary spindle 6 and its associated rotary motor 5 allows the holographic media 4 to be rotated about the axis 9, as indicated by arrow 9a. Additionally, the holographic media 4 is moved in the z direction via a linear motor 5 of translation stage 10 that the rotary motor is attached to. The linear motion in the z direction also allows the holographic media to be addressed by the holographic optical system provided by stationary write optical module 13 and read optical module 11. Each of the write and read modules are in general composed of a number of optical elements 14 and 12, respectively. In the specific example of a HDSS depicted by FIG. 1, light from an optical source 15 is split into two beams, reference beam 108 and object beam 109, via a beam splitter 16. Reference beam 108 passes through a beam steering system 17 that allows the reference beam to be swept to different angles of incidence on the holographic media. Depicted in FIG. 1 is an example of reference beam 108 steered to different positions 101 and 102 that may be incident upon the holographic media. The object beam 109 is preferably beam shaped by a beam shaping optical system 18 such that the intensity falling on the spatial light modulator (SLM) 19 is uniform. The light 100 from the SLM is relayed to the holographic media via the write module 13. To read data from the media, light 107 diffracted from the holographic media when illuminated by a reference beam is captured by the read module 11 and imaged onto a detector 103.

The HDSS require dynamic control and is connected via cables 110 (e.g., electrical or optical) to one or more controllers 106c. The controllers within the HDSS can perform a multitude of tasks including, but not limited to, the control and timing of the data displayed by the SLM, the modulation and power levels of the optical source, the decoding of data received from the detector, the servo controls for tracking the holographic media, and the control and timing of the reference beam wavefront and or angle required for the specific multiplexing configuration of the HDSS. The controller can also supply any electrical power needed by these various opto-mechanical systems via the connections illustrated by 110. The HDSS internal controller(s) are connected to an external controller 112 via a connection 111. This external controller could be a variety of controllers that include, but are not limited to, a personal computer, an enterprise library data storage system, or a computer server. The controller 106c may represent electronic, such as a programmed microprocessor based (or computer) system within housing 1. Signal may be sent or received by controller 106c from the components in housing shown for example by cables 110. For example, such signals send or received: signals to the motor for rotating gear 104; signals received from contact switch 104a; data signals representing data from detector 103 (or signals to detector 103 to control detector 103 operation); signals to beam steering system 17 to control angle of the reference beam; signals to the SLM 19 in accordance with data to be written; signals to source 15 to control operation of the source; signals to the positioning mechanism of stage 10 (in one or more orthogonal axes x,y,z) and via motor 5 (position along rotational axis 9 of the spindle). Thus, the holographic media is positioned by rotation about axis 9 and linear motion along axis z to write data or read data from media 4.

Other optical systems for read and/or write operations may also be used, such as described in U.S. Pat. No. 5,621,549, which is herein incorporated by reference. Although the holographic optics are preferably stationary, all or part of the optics may also be movable over the media. In addition to read or write operations, the holographic optical system may also provide searching operations to locate holographic recorded data on the media.

FIG. 1A shows that cartridge 3 can be partially outside of the housing 1 while the media 4 is being actuated outside of the cartridge. In this embodiment, either the cartridge and housing does not need to be light-tight, such as in the case of read-only (ROM) media, or the aperture 2 or any subsequent aperture within the housing 1 is sufficient to block light outside of the housing 1 from being incident upon the holographic media when the cartridge has been unlocked for read/write media.

FIG. 1B shows an example of another positioning mechanism by which the holographic media 4 of FIGS. 1 or 1A can be removed from the cartridge 3 containing such media when the media is in a rectangular card format. In this example, a side of the cartridge is hinged such that a shutter (or door) 151 opens enabling the media to be actuated outside of the cartridge. A pair of linear motors (or stages) 152 (e.g., piezo-electric enabled) actuates a pair of fixtures 153 that are slid by linear motors 152 first into the cartridge and then are mechanically secure, such as clamped, to the sides 154 of the holographic media prior to removal of the media from the cartridge. Motors 152 are controlled by controller 106c to position the media. The media is raised up from the bottom of the cartridge on low-friction members (e.g., bars or posts) 150 that are present inside of the cartridge. These low-friction members allow the holographic media to be slid along the z direction towards the holographic optical system by the linear motors 152, whereupon the media is then positionable by such motors 152 with respect to the write and/or read modules described earlier. To ensure that the fixtures 153 are not subjected to appreciable torque in the y direction, it is preferable that a portion of the rectangular media remains within the cartridge at any time during the reading or writing of the holographic media and supported by low-friction members 150.

Referring to FIGS. 2A and 2B, two examples of the light-tight aperture 2 of housing 1 are shown. In both FIGS. 2A and 2B, cartridge 3 is passed in and out along opening 20 in the housing 1. In FIG. 2A, the aperture is made light-tight via an opaque (non-light transmissive) door 21 that pivots on a rod of hinge 24. Optionally, a baffle or opaque flap may be provided over hinge 24 upon that ensures that the door 21 and hinge 24 remain light tight. The door 21 is light-tight since it contains recessed features 22 that mate with raised features 23 on the housing 1. Recessed features may represent one or more grooves or slots along the door which align and mate which raised ridges along the outside of housing 1 about the aperture. In FIG. 2B, the aperture 20 is made light-tight through the use of flexible sheets 25 that interlock and create a light-tight seal whenever the cartridge 3 is fully loaded or fully ejected. Sheets 25 are mounted from a pair of flanges 26 extending from the interior surface of housing 1 in opening 20 along the cartridge path into and out of housing 1. Although three sheets 25 are shown, any number of sheets 25 may be used to provide the desired interweave. Such sheets 25 may be made of material, such as plastic, which are non-transmissive to light, or such light wavelengths the media 4 is sensitive to.

An optional hub 8 of media 4 is shown in FIG. 3, which does not require the below described hub cover of shutter mechanism 106. The inner surface of the bottom 3b of the cartridge contains a series of annular raised annular members or ring 30 that interlock with raised annular members or rings 31 that are molded or otherwise attached to the holographic media 4, when the media 4 is contained in the cartridge. The material used for the rings 30 and 31 and the geometry in which they are constructed, along with the option of an opaque region 32 added to the holographic region, allows the cartridge to remain light-tight, while still allowing the system to have access to hub 8. Ridges 30 and 31 are such that ridges 30 in the hub cover rotate by approximately 180 degrees in order to allow the media to be actuated outside of the drive, and that the hub cover in the closed position provides enough overlap between ridges 30 and 31 such that the seam between the two is light-tight. Spring-loaded pins 34 can be employed to ensure that when the holographic media is locked inside of the cartridge the media remains in contact with rings 30 ensures a light-tight seal. When the media is inside the drive and ready to be actuated, pistons within the drive can be used that access said pins via holes 34 in the cartridge. The pistons can actuate pins 33 to release contact with the media and likewise can be actuated to make contact with the holographic media in a manner similar to how a ball-point pen with a spring-loaded tip can be actuated into and out of the circular tube of the pen.

Referring to FIGS. 4-7, an example of a cartridge 3 for housing a data storage media disk is shown. In this example, the cartridge is designed for a 130 mm diameter storage media such that the cartridge has dimensions of 135×135×11 mm. Similar cartridges can be extended to 120 mm diameter storage media (e.g., same diameter as DVDs and CDs), or other size storage media. Cartridge 3 has a housing 40 having an upper housing member 40a and a lower housing member 40b which mates with each other. Housing 40 has a circular chamber 42 containing media 4 having a vertical wall 43 that extends along the interior sides of chamber 42, a top wall 44, and a bottom wall 46. The interior of top wall 44 (shown in dotted line in FIG. 4) defining chamber 42 may be smooth and flat, or other contoured shape. A vertical wall 44a extends downward from top wall 44 and meets edge 43c of vertical wall 43 extending upwards from bottom wall 46. Vertical wall 43 is discontinuous about one side of the cartridge 3 to define window 105 between curved flanges 43a which extend from each end of vertical wall 43. The closed end 45a of slot 45 along the bottom wall 46 is shaped to enable access to hub 8 of the media, while the open end 45b of slot 45 extends to window 105 (FIG. 6). To provide a light tight seal about window 105, upper housing member 40a has two ledges 41a which mates with two edges 40d of the lower housing member 40b, as best shown in FIGS. 4 and 4C.

The cartridge in FIGS. 4A and 4B is completely closed and sealed to light penetration. For example, the housing 40 can be fabricated from aluminum, black polycarbonate, or clear plastic material that has a coating on either the inside or outside surface that only transmits light of a wavelength the holographic media is not sensitive to. In a specific example, consider the packaging of Type A holographic media manufactured and distributed by Aprilis, Inc., Maynard, Mass., U.S.A. This media has peak sensitivity at wavelengths about 548 nm and above 650 nm has virtually no reaction. Therefore, one may consider a cartridge material that could transmit wavelengths longer than 650 nm and block or all other wavelengths from transmitting.

The shutter mechanism 106 in the cartridge 3 is provided by a shutter member 106a and a hub cover or shutter 106b. Shutter member 106a has a vertical wall 48 of a length along at least half of the circumference of the circular chamber 42, a bottom wall 50, and a slot 52 opposite vertical wall 48. The vertical wall 48 and bottom wall 50 of shutter member 106a meet to form a surface 54, which may be angled, such as 45 degrees. Angled surface 54 extends from one end 54a along the circumference of the shutter member 106a to another end 54b. A circular row of teeth provides a gear track 55 on angled surface 54 along the outer circumference of shutter member 106a. The chamber bottom wall 46 may be slightly concave and shutter bottom wall 50 is also slightly concave such that it is slidable along bottom wall 46 when rotated in chamber 42. Friction can be reduced by having concave walls, but one may also use other specific wear zones (e.g., raised dots, ribs, etc.) that may incorporate low-friction materials that are different from the materials of walls 50 and 46. The vertical wall 48 of shutter member 106a rides in a vertical slot or track 49 in the upper housing member 40a along a downwardly curved edge 40c of top wall 44 which provides a lip above window 105, and such track 49 extends through steps 41b adjacent ledges 41a. An upwardly curved edge 46f of bottom wall 46 provides a lip below window 105 on either side of slot 45. A stop 47 abuts end 48a of the vertical wall 48 of the shutter member 106a when the shutter member is fully rotated to close window 105, or end 48b when the shutter member is fully rotated to open window 105. The top edge 40c is thus mated with a circular slot 49 in the top wall 44, creating an overlap between shutter member 106a and top wall.

The hub cover 106b is disposed in a recessed region 46a along the interior of bottom wall 46 between bottom wall 46 and shutter member 106a. The hub cover 106b is rotatably mounted in chamber 42 via a hole 58 of hub cover 106b upon a pivot post 56 extending from bottom wall 46. The hub cover 106b may be coupled for rotation upon post 56 with either a mechanical fastener (such as an E-ring on the post 56), or a washer and heat stake. A heat stake is the formation of a rivet head on the top of a post usually by means of heat or physical deformation. Hub cover 106b has at one end a lobe 60 and at the other end a drive pin 61. The drive pin 61 may be a cylindrical member protruding from the surface of the hub cover 106b. When shutter member 106a is fully rotated to close window 105, the drive pin 61 is received in a notch 62 of the shutter member 106a. A torsion spring (or a linear extension spring) 56a is provided about post 56 having ends that abut the hub cover 106b and the chamber bottom wall 46. The torsion spring biases the hub cover 106b in its closed position (in a clock-wise direction from top view). The pocket shape of region 46a cut into the interior surface of the cartridge bottom wall 46 forms an optional stop wall 46c which may be provided for the hub cover 106b when rotated to its closed position. Optionally, wall 46d for the hub cover 106b may provide a stop when the hub cover is rotated to its open position. Preferably, hub cover 106b does not require a stop as the open and close stop positions of hub cover rotation is determined by the open and close positions, respectively, of the shutter mechanism 106a. The hub cover and shutter member may be fabricated from the same material providing housing 40.

The assembled cartridge with the shutter member 106a and hub cover 106b in a closed position over window 105 is shown in FIGS. 4A and 4B, such that vertical wall 48 is disposed in track 49 between upper and lower curved edges 40c and 46f and abuts stop 47, and lobe 60 of the hub cover 106b lies over the closed end 45a of slot 45. A light-tight seals is thus provided preventing light from entering the chamber 42 containing the media 4 through window 105 or slot 45. When inserted into the holographic drive as described earlier, a gear 104 having teeth 53a mates with the teeth of gear rack 55 of shutter member 106a (FIGS. 5 and 5A). FIG. 5 depicts an example of a gear motor 53b (which is mounted to the cartridge loader in the drive) engaged with the shutter gear rack 55. A shaft 53c couples rotation of the motor 53b to gear 104. Rotary motion of the gear motor 53b will thereby cause a rotary motion of the shutter member 106a thereby opening the window 105. A clearance notch 46e is provided along edge 46f of the lower housing member 40b adjacent gear rack 55 upon which gear 104 is located to engage the gear rack.

To open window 105, the gear 104 is driven by motor 53b to rotate shutter member 106a clockwise (from a top view) sliding vertical wall 48 of the shutter member 106a in track 49 and then along vertical walls 43, until end 48b of vertical wall 48 of the shutter member 106a abuts stop 47, thereby fully containing shutter member 106a in chamber 42 and aligning slot 52 of shutter member 106a to coincide with slot 45 in chamber bottom wall 46. Hub cover 106b rotates in response to rotation of shutter member 106a when drive pin 61 rides along a cam surface 51 of the shutter member 106a rotating the hub cover 106b in a clockwise direction against the bias of spring 56a to pivot lobe 60 away from slot 45, and enable access to the hub 8 of media 4. When shutter member 106a drives against stop 47 to limit its travel in either its open or close positions, this in turn also limits the hub cover 106b travel. Other means may also be provided to determine when shutter member 106a is fully open or closed. For example, in addition to the mechanical stop 47, optical or mechanical sensor(s) may be provided in housing 1 to detect (via signals to controller 106c) the shutter member 106a position to control the on/off function of the driving gear motor 53b that moves the shutter member 106a. In a further example, mechanical stop 47 is used and the current of external motor 53b is monitored (via signals to controller 106c) to determine which mechanical stop 47 has reached shutter member 106a.

FIG. 6 shows the shutter member 106a and hub cover 106b in their open position. The entire front half of the holographic media 4 is free from obstruction and as such the media can be removed from the cartridge 3. This enables hub 8 of media 4 to engage spindle 6 upon which the media may be removed to a location partially or fully out window 105, as described earlier. In FIG. 7, the media 4 is shown partially removed from the cartridge 3 through window 105. In order to achieve the partial removal of the holographic media from the cartridge 3, the chuck 7 of the rotary spindle 6 of the HDSS contacts with the hub 8 of the holographic media. The holographic media 4 and the chuck 7 are illustrated in an exploded view in FIG. 7 for visual clarity. After the media 4 is inserted back in the cartridge 3, the spindle 6 is detached from the hub 8, and the gear 104 is driven by motor 53b in the reverse direction to return shutter member 106a and return hub cover 106b to their closed light-tight position over window 105.

The cartridge upper and lower housing members 40a and 40b have walls 63a and 63b, respectively, continuous with the top wall 44 and bottom wall 46, respectively, which mate with each other to define a rectangular end of the cartridge opposite window 105. Notches 40e may be provided for optional use by the other loaders external of housing 1 of the system to grab the cartridge, such as in a library system. For example, the cartridge may have notches 40e, as well as the holes 64, 66, and 68, such as described in an international standards document ISO/IEC 10089 title “Information technology—130 mm rewriteable optical disk cartridge for information interchange”. For the case of notches 40e, these are similar to notches for 5¼ inch MO (Magnetic-Optical) cartridges such that the MO cartridges can be grabbed by the robotic cartridge handling system within an automated MO library. This can allow for the efficient containment of a 130 mm data storage media while conforming to many of the specifications described in ISO/IEC 10089 and allowing for the complete front of the cartridge to open up thereby allowing for the actuation of the storage media outside of the cartridge.

Screws may couple the upper and lower housing member 40a and 40b together which are received through holes 64 (FIG. 4B) through bosses 65 (FIG. 4) in the upper and lower housing members. Hole 66 may be provided through which an optical sensor in housing 1 can detect when a cartridge is present and/or is write protected. A boss 66a for the hole 66 extends through the upper and lower housing members 40a and 40b. Likewise, bosses 65 for holes 64 extend through the upper and lower housing members 40a and 40b. Holes 68 may be provided in the lower housing member 40b which may be used by the cartridge driver in housing 1 of the system for aligning and locating the cartridge. A boss 68a for the hole 68 extends through the upper and lower housing members 40a and 40b. For purposes of illustration, bosses 65, 66a, and 68a are only shown along lower housing member 40b. All the holes 64, 66, and 68 are surrounded by walls that fit closely with mating surrounds in the top housing member 40a. These surrounds serve the dual purposes of sealing out light, and providing mechanical alignment and support for the assembled cartridge. The upper and lower members 40a and 40b may be made of molded plastic material suitable for blocking light or being coatable with light blocking material.

The cartridge shutter member 106a and hub cover 106b may be locked so that they cannot be opened without the appropriate unlocking mechanism as would be contained within the inside of the mating HDSS. One example of the interlock mechanism is to employ a simple spring and lever arrangement that engages a detent in the shutter. An access hole in the cartridge walls 63b and 43 (or in wall 44 or wall 46) will allow a plunger from the disk drive to push the lever out of the detent, freeing the shutter member 106a to rotate. A light-tight lever is provided so that the access hole in the cartridge need not create a light leak. Another example of a locking means is a magnetic latch and spring. In this example, a spring holds the locking lever into the shutter detent. A magnet (or magnetizable keeper) is located in a position so that a magnet in disk drive will pull the detent lever out of the locked position. The advantage of the magnetic latch is twofold: no chance for light to leak; and no access hole for curious users to poke at and accidentally unlock the shutter member and ruin their data. A redundant magnetic latch on either side of the cartridge may be provided for additional protection.

The cartridge 3 of FIGS. 4-7 may be slightly larger than the media disk 4 itself. The shutter mechanism provides means for creating an opening for the media disk 4 to pass partially or completely outside the cartridge without increasing the outside boundaries of the cartridge when closed. Thus, the optics of the holographical optical system can be physically close to the outer diameter (OD) of the media disk (i.e., no swinging door to stay away from), and promotes compactness of the housing 1 of the holographic drive.

There are several features of the compact removable-disk cartridge 3: (1) The shutter rotates about the disk center, so clearance between the shutter and disk OD is preserved in all positions (open, closed, and during motion); (2) the curved “wraparound” flanges (or tabs) 43a in FIG. 4 can prevent a straight-line path for light to enter the space between the closed shutter 106 and cartridge housing 40; and (3) the smallest inside distance between the two “wraparound” flanges 43a is slightly larger than the OD of the disk 4 (e.g., approximately 1 mm clearance). Further, the cartridge 3 is scalable to other sizes for any circular shaped disk. Earlier mentioned examples of storage disks protected by a cartridge with a covered data access window of Sparq, Blue-ray, 3.5″ floppy disk, or MO (Magnetic-Optical) disks, do not provide a disk which is capable of being fully removable from their cartridges in a drive.

Although the positioning mechanism for the media to a position fully or partially from the cartridge is coupled to the media through a bottom wall of the cartridge, instead such coupling of the positioning mechanism to the media (e.g., via spindle) may be through an opening similar to slot 45 through the top wall of the cartridge with the hub covering means of FIG. 3 or hub cover 106b oriented in a direction facing the cartridge top wall. Further, the cartridge may have two slots such that the bottom wall has a slot 45 and the top wall also has an opening similar to slot 45, whereby the cartridge may be used in different HDSS with either top, or bottom slot enabled media positioning mechanisms. Thus, such a cartridge may have an upper hub cover as well as lower hub cover 106b, both rotatable by shutter member 106a which has features for engaging both hub covers in the same manner as described above for a single hub cover.

In the cartridge, the media disk 4 may sit on three or more support tabs 70 mounted in a spaced relation along the interior of the shutter vertical wall 48 (FIG. 4). The purpose of the tabs 70 to hold the disk hub above the hub cover 106b to avoid rubbing (or a mechanical interference) when actuating the hub cover. The tabs 70 are located so that the disk 4 is not in contact with them once the cartridge is in its loaded position on the disk chuck 7. For purposes of illustration, only one tab 70 is shown. Multiple ones of such tabs are distributed around the interior circumference of vertical wall 48. The cartridge, via the cartridge loader, will therefore drop down more than the disk, so a gap opens between the support tabs 70 and disk 4 upon loading. When the disk is unseated from the hub 8 to unload the cartridge 3, the support tabs 70 contact the disk 4 and lift it off the chuck. The disk is lifted high enough in the cartridge for the hub cover to swing shut without scraping the disk hub.

The shutter member 106a thus combines several functions in one part. It acts as a door for blocking the window 105 through which the disk exits and enters the cartridge housing. The shutter member 106a acts as a light seal to prevent exposure of the photo-sensitive disk. Third, the shutter member 106a acts as an actuator for the hub cover 106b. Fourth, it provides a gear rack 55 upon which motor 53b with a complementary gear 104 (or friction drive, or spoke drive) engages the shutter gear rack 55 to actuate opening or closure of window 105. The light seal of the shutter member 106a is accomplished on the bottom by molding or forming the shutter member from one piece of material without holes. All the interior surfaces of chamber 42 in the cartridge are appropriately textured and painted (or molded) material with excellent optical absorption to minimize light scatter off surfaces that may provide a path into the disk 4.

As described earlier, if the HDSS operates only upon a read-only HDSS and a read-only holographic media, the HDSS and the cartridge 3 for the read-only holographic media need not be light-tight. For the read-only HDSS, for example, one does not require the aperture 2 through which the cartridge is inserted to be light-tight. The cartridge 3 for the read-only holographic media, for example, could be fabricated from a transparent or translucent material such as certain grades or compositions of acrylics and polycarbonates. In the read-only media case, optionally no cartridge is required to house the holographic media and instead the bare media may be handled and insert it into the HDSS. This invention would still apply in that the HDSS could be actuating the media linearly or in more than one direction across the optical pickup of the HDSS.

The system for enabling a data storage media to be actuated to positions partially or completely outside of the cartridge that originally housed said media is not limited to holographic data storage applications, but for all data storage applications including, but not limited to other forms of optical data storage as well as magnetic data storage.

Although the cartridge has been shown to having a window, alternatively, the cartridge may be of a clamshell housing such that when the cartridge is loaded into the drive, the top half and the bottom half of the cartridge housing opens up, via a spring on the back of the cartridge, thereby allowing the data storage media to be actuated outside of the cartridge that originally housed said media. In another example, the shutter member 106a need not be a rotary one that slides open and closed, but could be a shutter (or door) that flips open or closed.

Thus, the present invention provides placement of a holographic media within a package, referred to herein as cartridge 3. The cartridge is capable of being loaded into a HDSS via an external aperture 2 of the HDSS. Once the cartridge 3 is inside of the HDSS, a portion of the cartridge opens to allow the positioning mechanism of the HDSS to partially or completely remove the holographic media 4 from the cartridge 3 and to position or move it over the write and/or read optical system of the HDSS. Once the writing and/or reading process is completed, the HDSS positioning mechanism reinserts the holographic media within the cartridge and the cartridge is ejected from the HDSS.

As stated earlier, for a HDSS that is capable of recording data to writeable holographic media, the preferred embodiment has light-tight requirements on both the HDSS and the cartridge of the writeable holographic media. The term “light-tight” is defined herein as the property of a physical barrier wherein, if the barrier does transmit electro-magnetic radiation, the barrier only transmits electro-magnetic radiation that the holographic media for a specific application is not sufficiently sensitive to so as to cause an undesired change in the holographic media that in some manner compromises the performance that the holographic media was designed for. Such transmitted electro-magnetic radiation means radiation the cartridge would be expected to encounter during normal use and operation. In this embodiment, the cartridge is preferably made from materials, coated material, or composites of materials that achieve a light-tight cartridge at the wavelengths that the holographic media is sensitive to, as well as a cartridge wherein all seams of the cartridge are made light-tight through the use of light baffling geometries or other means. Any doors, apertures, or windows allowing access to the holographic media are made light-tight through a locking mechanism or other light baffling or absorption geometries. In a preferred embodiment, a lock-mechanism is integrated into the cartridge such that the door, aperture, or window that allows access to the holographic media cannot be opened without a suitable unlocking mechanism.

For the HDSS capable of writing to holographic media, the external aperture 2 of the HDSS through which the cartridge 3 is inserted is preferably light-tight. Although the external aperture need not to be light-tight during the loading or unloading of a cartridge, in the preferred embodiment, when the cartridge 3 is either fully inserted into the HDSS or when the cartridge is fully ejected from the HDSS, the external aperture maintains a light-tight seal.

Within the HDSS, a cartridge loader may be provided which engages the cartridge and can be used to pull said cartridge into the HDSS. The cartridge loader is such that the cartridge aperture allows access to the media and the aperture does not open until the cartridge is fully within the HDSS and the external aperture of the HDSS is light-tight. Optionally, the cartridge may be partially loaded sufficient to access the media in which the light cannot pass through the gap between the cartridge and the aperture. When the HDSS is light-tight again after insertion of the cartridge, a motor driven mechanism opens the cartridge such that the holographic media within said cartridge can be removed. The positioning mechanism of the HDSS then remove the holographic media from the cartridge and scan the holographic media over the optical pickup of the HDSS. In one embodiment, the scanning of the holographic media can be accomplished via a rotation and a radial translation in the case of holographic media that is in the format of a disk. In another embodiment, the scanning of the holographic media is accomplished in an x-y format or another motion format that is capable of accessing the full 3-D profile of the holographic media. As an example, holographic media in the form of a planar card can be removed from the cartridge and the holographic media can be scanned in x and y (two non-parallel axes of motion that lie in the plane of the surface of the holographic media) or the holographic media can be scanned in only x or y and the write optical head of the HDSS can be scanned in another non-parallel axis of motion such that the entire surface of the holographic media can be accessed.

As stated earlier, if the HDSS operates only as a read-only HDSS and hence uses only read-only holographic media 4, the HDSS and the cartridge 3 for the read-only holographic media need not be light-tight. For the read-only HDSS, for example, one does not require the aperture 2 through which the cartridge 3 is inserted to be light-tight. The cartridge for the read-only holographic media, for example, could be fabricated from a transparent or translucent material such as certain grades or compositions of acrylics and polycarbonates. In this embodiment, the aperture of the cartridge through which the holographic media is accessed need not be light-tight. In another embodiment of the read-only media case, one can forego the use of a cartridge to house the holographic media and instead handle the bare media and insert it into the HDSS. This invention would still apply in that the HDSS could be actuating the media linearly or in more than one direction across the optical pickup of the HDSS.

Another example of a HDSS system that may not require the condition of a light-tight housing and/or a light-tight cartridge, is one that is bit-based, see for example, S. Orlic et al., “3D bit-oriented optical storage in photopolymers”, J. of Optical A: Pure Appl. Opt., Vol. 3, pp. 72-81 (2001). In bit-based HDSS, the holographic data is recorded one bit at a time, instead of an array of bits, either 1-D or 2-D, as the recording is in page-based systems. In bit-based recording, the bits are recorded in the volume of the HDSS media, but within said volume of the media, the desired recording spot size may be on the order of a few cubic microns, as opposed to tens of thousands of cubic microns for some page-based holographic systems. As a consequence, holographic media for bit-based systems may have a thresholding requirement such that recording within the holographic media can only take place if the media is exposed to a very high optical power density. The power density threshold may be higher than that received through exposure to normal room lights of an office or home environment, and may also be envisioned to be a higher power density than would be received by the non-focused rays of the sun if the media is carried outdoors. The bit-based HDSS and associated media may therefore not require a light-tight specification, even though the HDSS and media for recording (writing) of data and therefore not restricted to only reading data.

From the foregoing description it will be apparent that there has been provided improved system, apparatus, and method for accessing holographic media in a holographic drive of a holographic data storage system, and media containing cartridges for use therewith. The illustrated description as a whole is to be taken as illustrative and not as limiting of the scope of the invention. Such variations, modifications and extensions, which are within the scope of the invention, will undoubtedly become apparent to those skilled in the art.

1. A cartridge for data storage media receivable in a data storage drive comprising a chamber for receiving data storage media, said chamber having a window and at least one member closing said window, in which said member is movable to open said window to enable at least part of said media to be moved through said window outside the boundaries of said cartridge in the data storage drive.

2. The cartridge according to claim 1 wherein member represents a first member, and said chamber has an opening and a second member closing said opening movable to open said opening, and when said opening is opened said media is engagable through said opening is of sufficient size to move at least a part of said media outside the boundaries of said cartridge.

3. The cartridge according to claim 2 wherein movement of said first member to open and close said window is coupled to said second member to open and close said opening.

4. The cartridge according to claim 2 wherein said chamber has one wall with said window and another adjacent wall, and said opening represents a slot along said another wall which extends to said one wall in communication with said window.

5. The cartridge according to claim 1 wherein said cartridge represents a housing receivable in an aperture of a data storage drive.

6. The cartridge according to claim 1 wherein said chamber has a substantially cylindrical interior wall having said window, said member represents a a shutter rotatable along the interior wall of said chamber which in a first position closes said window and in a second position opens said window.

7. The cartridge according to claim 6 wherein said shutter has an external track engagable with a gear in the data storage system to rotate said shutter.

8. The cartridge according to claim 6 wherein said chamber has a bottom wall with opening through which the data storage drive engages said media to move at least part of said media through said window, and a part of said shutter extends along said bottom wall in said first position to close at least part of said opening.

9. The cartridge according to claim 8 wherein said chamber further comprises a hub cover to cover the remaining part of said opening when said shutter is in said first position, and said hub cover is coupled for rotation to said shutter in a first direction away from said opening when said shutter is rotated to a second position to open said window.

10. The cartridge according to claim 9 wherein said hub cover is coupled for rotation to said shutter in a second direction toward said opening when said shutter is rotated to a first position to close said window

11. The cartridge according to claim 10 wherein said hub cover is spring biased toward rotation in said second direction, and said hub cover couples said bias to said shutter to rotate to said shutter toward said first position.

12. The cartridge according to claim 8 wherein said media has ridges, and said hub cover when closed has ridges which intertwine with ridges of said media to prevent light from entering through said opening.

13. The cartridge according to claim 1 wherein said cartridge represents a housing receivable in a data storage drive, and said data storage drive has positioning means attachable to said media through said window for moving at least part of said media through said window.

14. The cartridge according to claim 13 wherein said positioning means is attachable to at least two sides of said media to move said media in multiple dimensions.

15. The cartridge according to claim 14 wherein said positioning means comprises two fixtures securable to the sides of the media.

16. The cartridge according to claim 15 wherein said positioning means comprises two stages coupled to said fixtures to move said media in multiple dimensions.

17. The cartridge according to claim 1 wherein said media is holographic data storage media, and at least part of said media when located outside the boundaries of said cartridges is actuated upon by a holographic optical system.

18. The cartridge according to claim 17 wherein said cartridge allows light to reach said media in said cartridge when said media represents only read holographic data storage media.

19. The cartridge according to claim 1 wherein when said member closes said window, said cartridge blocks light to said media to which said media is sensitive.

20. The cartridge according to claim 1 wherein said media contained in said cartridge represents optical data storage media.

21. The cartridge according to claim 1 having means for maintaining said member closed until opened in the data storage drive.

22. A data storage system utilizing data storage media contained in cartridges comprising:
one or more cartridges having data storage media, a window, and a member closing said window, in which said member is engagable to open said window;
a housing having an optical system for at least one of reading, writing, or reading and writing data on data storage media, and an aperture through which one of said cartridges is partially or fully received in said housing;
means for engaging said member to open said window of said one of said cartridges when said one of said cartridges is received through said aperture of said housing; and
means for positioning said media partially or fully from the cartridge through said window to present said media to said optical system, and after presentation to said optical system to locate said media back into said cartridge through said window and operating said engaging means to close said window prior to removal of said one of said cartridges from said housing through said aperture.

23. The system according to claim 22 wherein said optical system represents an optical data storage system.

24. The system according to claim 22 wherein said optical system represents one of a magnetic-optical, holographic, CD, or DVD data storage system.

25. The system according to claim 22 wherein said aperture has means for preventing light from entering the housing after the cartridge passes through said aperture.

26. The system according to claim 22 wherein a portion of said cartridge is partially located outside of said aperture when said window is opened, and said aperture has means for preventing light from entering the housing.

27. The system according to claim 22 wherein said housing is non-transmissive to at least light to which the media is sensitive.

28. The system according to claim 22 wherein positioning means further comprises an opening in each of said cartridges for attaching said media to said positioning means, and said positioning means has means in said housing for attached to said media via said opening and moving at least part of said media through said window when opened outside the boundaries of the cartridge to locate locations on said media with respect to said optical system.

29. The system according to claim 22 wherein in each of said cartridges said member represents a first member, and said chamber has an opening and a second member closing said opening movable to open said opening, and when said opening is opened said media is engagable through said opening is of sufficient size to move at least a part of said media outside the boundaries of said cartridge.

30. The system according to claim 29 wherein in each of said cartridges movement of said first member to open and close said window is coupled to said second member to open and close said opening.

31. The cartridge according to claim 30 wherein in each of said cartridges said chamber has one wall with said window and another adjacent wall, and said opening represents a slot along said another wall which extends to said one wall in communication with said window.

32. The system according to claim 22 wherein in each of said cartridges has a housing with said chamber receivable in an aperture of a data storage drive.

33. The system according to claim 22 wherein in each of said cartridges said chamber has a substantially cylindrical interior wall having said window, said member represents a shutter rotatable along the interior wall of said chamber which in a first position closes said window and in a second position opens said window.

34. The system according to claim 33 wherein in each of said cartridges said shutter has an external track engagable with a gear in the data storage system to rotate said shutter.

35. The system according to claim 33 wherein in each of said cartridges said chamber has a bottom wall with opening through which the data storage drive engages said media to move at least part of said media through said window, and a part of said shutter extends along said bottom wall in said first position to close at least part of said opening.

36. The system according to claim 35 wherein in each of said cartridges said chamber further comprises a hub cover to cover the remaining part of said opening when said shutter is in said first position, and said hub cover is coupled for rotation to said shutter in a first direction away from said opening when said shutter is rotated to a second position to open said window.

37. The system according to claim 36 wherein in each of said cartridges said hub cover is coupled for rotation to said shutter in a second direction toward said opening when said shutter is rotated to a first position to close said window

38. The system according to claim 37 wherein in each of said cartridges said hub cover is spring biased toward rotation in said second direction, and said hub cover couples said bias to said shutter to rotate to said shutter toward said first position.

39. A method for data storage utilizing media contained in cartridges comprising the steps of:
providing a housing having an optical system for at least one of reading, writing, or reading and writing data on holographic data storage media;
receiving a cartridge fully or partially through an aperture in said housing;
removing the media partially or fully from the cartridge received in said housing to present said media to said optics; and
inserting said media back into said cartridge after presentation to said optics.

40. The method according to claim 39 wherein said cartridge has a window which is normally closed when said cartridge is outside said housing, and said removing step further comprises the steps of:
opening said window; and
positioning said media partially or fully from the cartridge through said opened window to present said media to said optics.

41. The method according to claim 40 further comprises the step of closing said window after said inserting step.

42. The method according to claim 39 wherein the cartridge prevents light from reaching said media when said cartridge is located outside said housing.

43. The method according to claim 39 wherein when said media is read-only holographic data storage media and said cartridge allows light to reach said media.

44. A cartridge for an optical data storage media comprising:
a housing of non-light transmissive material having a window through which the media is passable there through into or out of said housing; and
means for opening and closing said window.
